(19) United States
(12) Patent Application Publication
(10) Pub. No.: US 2007/0006162 A1
(43) Pub. Date: Jan. 4, 2007

(54) Method, terminal device and computer software for changing the appearance of a visual program representative

(75) Inventor: Jari Iho, Helsinki (FI)

Correspondence Address: HARRINGTON & SMITH, LLP, 4 RESEARCH DRIVE, SHELTON, CT, 06484-6212, US

(73) Assignee: Nokia Corporation

(21) Appl. No.: 11/174,105

(22) Filed: Jun. 30, 2005

(51) Int. Cl. G06F 9/44

(52) U.S. Cl. 717/127; 715/866

(57) ABSTRACT

A method, a terminal device and a computer software for changing the appearance of a visual program representative, which is produced on the display of the terminal device are disclosed. In the method the operation frequency of the program is observed and measured for a predetermined period of time. After this the appearance of the visual program representative is changed such that the changed appearance reflects the operation frequency of the program during the past observation period. If the program has not been used during the past observation period, the appearance of the visual program representative is chanced to a less noticeable form e.g. by diminishing the size of the visual program representative. If the program has been used during the past observation period, the original appearance of the visual program representative is recalled. Method steps are repeated in cycles for changing the appearance of the visual program representative continuously.

### FIELD OF THE INVENTION

The present invention relates to a method, terminal device and computer software for changing the appearance of a visual program representative, which is produced on the display of the terminal device.

### BACKGROUND OF THE INVENTION

Nowadays terminal devices such as personal computers (PC) and mobile communication devices are commonly run by an operating system (OS) that provides a graphical operating environment for the user. Some of the well-known graphical operating systems are Windows-based operating systems (eg. Windows ME and Windows XP) for PCs and Series 60/90 Platforms built on Symbian Operating systems for mobile devices. The user may interact with the device through a Graphic User Interface (GUI), which comprises visual program representations, such as icons and windows. The user may open a program by selecting or clicking an icon, which represents the program in question. The program is then opened in a separate application window, which is produced on the display of the device.

Commonly used operating systems are supporting multiple tasking, which means that several applications can be opened simultaneously. However, most of the time the users are actively using only few major applications, e.g. in PC/Windows environment E-mail, word processing and a Web browser and in mobile devices perhaps E-mail program and calling and messaging services. Despite the fact that usually only few applications are frequently used, also all the icons of seldom or hardly ever used applications are produced on the display every time the device is opened. In Windows environment is it also common that there are often numerous opened applications running “behind” the currently used application, i.e. the application windows are opened one upon the other and only the one which is on top is actually in use. Keeping the hidden application windows opened all the time and producing the unnecessary, seldom used icons on the display consumes the processing power and memory capacity of the device and covers the display area needlessly.

Document US 2004090470 discloses a method, display system and computer software for controlling icon-appearance. The appearance of the icon is changed by manual input commands given by the user of the device. The purpose of this solution is to make manual changing and adjusting the icon appearance easier for the user.

### SUMMARY OF THE INVENTION

An object of the invention is to provide a method, a terminal device comprising a display and a computer program for changing the appearance of the visual program representatives, such as icons and windows, on the display to obviate the problems and disadvantages of the Prior Art.

An advantage of the invention is that it reduces the memory consumption of the terminal device.

Another advantage of the invention is that it reduces the power consumption of the terminal device. This is especially advantageous in mobile devices because lower power consumption means also extended battery life.

A further advantage of the invention is that it improves the usability of the most used applications.

To achieve these objects and other advantages a method for changing the appearance of a visual program representative, which is produced on the display of the terminal device, is provided. The method comprises the steps of observing the operation frequency of the program represented by the visual program representative for a predetermined period of time, measuring the operation frequency of the program during observation period and changing the appearance of the visual program representative such that the changed appearance reflects the operation frequency of the program during the past observation period. Preferably the appearance of the visual program representative is chanced to a less noticeable form, if the program has not been used during the past observation period. The changing of the appearance of the visual program representative may be made by diminishing the size of the visual program representative or by changing the colouring of the visual program representative. If the program has been used during the past observation period, the original appearance of the visual program representative may be recalled.

Preferably the method steps are repeated in cycles for observing, measuring and changing the appearance of the visual program representative continuously. The visual program representative may be removed from the display, if the program has not been used during predetermined number of consecutive observation periods. Also the program represented by the visual program representative may be closed, if the program has not been used during predetermined number of consecutive observation periods.

In another aspect of the present invention, a terminal device is provided, which automatically changes the appearance of the visual program representatives produced on the display. The terminal device comprises a memory for storing the information concerning the appearance of a visual program representative, a display for displaying visual program representatives and a display controller coupled to the memory and the display. The display controller observes the operation frequency of the program represented by the visual program representative for a predetermined period of time, called the observation period, and measures the operation frequency of the program during observation period. Finally, the appearance of the visual program representative is changed such that the changed appearance reflects the operation frequency of the program during the past observation period.

In another aspect of the present invention, a computer software product for changing the appearance of a visual program representative of a terminal device comprising a display is provided. The computer software product comprises a computer-readable medium storing program code for changing the appearance of a visual program representative produced on a display of a terminal device. When the program code is executed by the display controller, it causes the display controller to observe the operation frequency of the program represented by the visual program representative for a predetermined period of time, called the observation period, and to measure the operation frequency of the program during observation period. The program code further causes the display controller to change the appearance of the visual program representative such that the changed appearance reflects the operation frequency of the program during the past observation period.

It is to be understood that both the foregoing general description and the following detailed description of the present invention are exemplary and explanatory and are intended to provide further explanation of the invention as claimed.

### BRIEF DESCRIPTION OF THE DRAWINGS

The invention is described in detail below. Reference is made to the accompanying drawings in which

FIG. 1 shows a schematical representation of a terminal device according to the invention and

FIG. 2 shows as an exemplary a flow chart including main stages of the method according to the invention.

### DETAILED DESCRIPTION

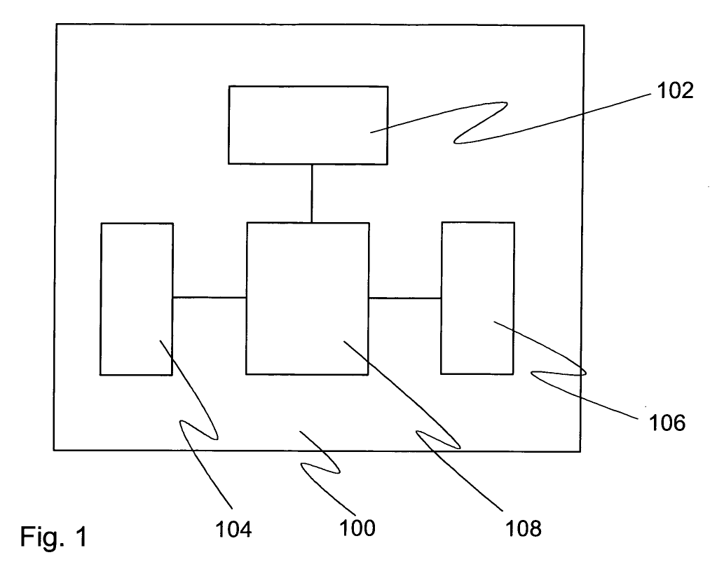

FIG. 1 illustrates a terminal device according to the present invention. The device may be any computerized device comprising a display, such as a personal computer (PC) or a workstation, a laptop computer, a personal digital assistant (PDA), a palmtop or a mobile communication device, such as a cellular phone. Referring to FIG. 1, the terminal device 100 includes a display 102, a memory 104, user interface unit 106 and a display controller 108. The user interface unit may be any input-unit such as a keyboard, mouse or a touch pad. The display controller 108 may be a processor or a program that controls the content of the display. The memory 104 may be in a form of magnetic disk, magnetic tape, optical disk or other data storage device. The display may be a cathode ray tube or preferably a flat panel display such as a liquid crystal display (LCD). The display may also be a so-called touch-sensitive display whereby the display may also act as user interface unit.

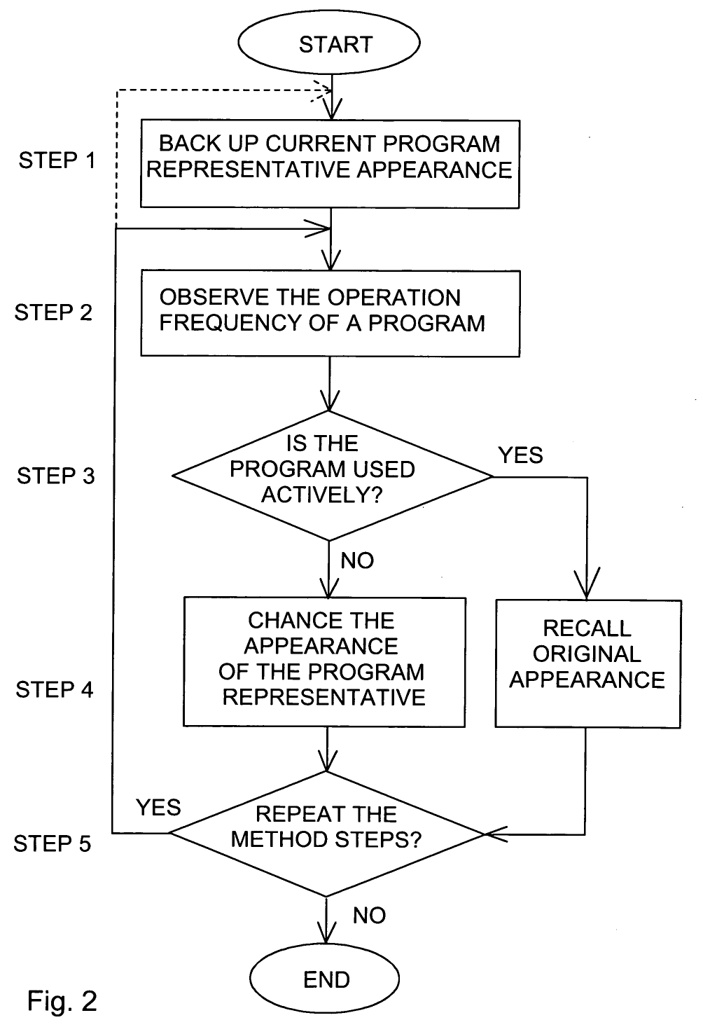

FIG. 2 shows a flow chart illustrating the main steps of the method according to the invention for changing the appearance of a visual program representative, which is produced on the display 102 of the terminal device 100. The method starts when the terminal device is switched on and the display controller 108 produces the visual program representatives i.e. the program icons on the display of the device. The first method step is to back up the display properties relating to the current appearance of the visual program representation in the memory 104 of the terminal device. This step is not necessary if the appearance of the visual program representatives is already saved into the memory by other methods or applications executed in the terminal device.

The second step of the method is to observe the operation frequency of the program icons produced on the display for a predetermined period of time, which is here called the observation period. In the observation so-called aging parameter is used. In the beginning of the method the starting value of the aging parameter is zero. If the user of the terminal device opens the program e.g. by clicking the program icon or uses the opened program, the program is considered to be active during the observation period and the value of the aging parameter is set zero. Correspondingly, if the program is considered to be inactive during the observation period, i.e. it is not opened or the opened program is not used, then the value of the aging parameter is added by one. The length of the observation period can be selected by the user of the device. For measuring the length of the observation period, the terminal device is provided with a timer.

The third step of the method is to measure the operation frequency of the program by checking the value of the aging parameter. In step four the appearance of the visual program representative, i.e. the program icon, is changed such that the changed appearance reflects the operation frequency of the program during the past observation period. If the value of the aging parameter is more than zero, it means that the program has not been used during the observation period. In this case the appearance of the program icon is “weakened”, i.e. chanced into less noticeable form. This weakening can be done in several different ways like by diminishing the size of the program icon or by altering the colouring of the icon e.g. by chancing the colours of the icon closer to the colour of the display's background colour or by replacing coloured areas (pixels) by grey-scaled areas. The changed appearance of the icon is then produced on the display 102 of the terminal device 100 by the display controller 108 replacing the original icon appearance.

If the value of the aging parameter (in step 3) is zero, it means that the program has been used during the past observation period. In this case the original appearance of the icon is recalled in step four and the icon is then produced on the display 102 of the terminal device 100 in its original appearance.

In fifth step of the method it is decided, whether or not steps 2 to 4 are repeated. In the current invention this decision can be made automatically by setting an upper limit to the value of the aging parameter. If the value of the aging parameter is less than the upper limit, the method returns automatically back to step 2 and the method continues as described before. If the value of the aging parameter is equal to the upper limit, the visual program representative is removed from the display and the method stops. The value of the upper limit can be set by the user of the device or it can be set automatically. Preferably the value of the upper limit is chosen such that when the aging parameter reaches the upper limit, the appearance of the icon is already considerably weakened, and further weakening of the icon is no longer reasonable.

In the above-described embodiment of the method the information concerning the changed appearance of the visual representative of the program disappears, when the terminal device is switched off. This means that when the terminal device is switched on again, the program icons produced on the display of the device have their original “normal” appearance.

In a preferred embodiment of the method according to the invention the information concerning the latest appearance of the program representative is saved into the memory 104 of the terminal device 100. This is implemented in such a way that every time a new method cycle starts, step 5 is followed by step 1 (dashed line in FIG. 2). This means that after each method cycle, the latest version of the visual program representative is always saved to the memory of the device. When the terminal device is switched on, the program icon produced on the display of the device has the same appearance it had, when the device was last switched off. Otherwise the method works similarly as described above.

In the above-described embodiments of the method the visual representative of the program was a program icon. The method according to the invention applies also for other visual program representatives, such as application windows, which are produced on the display of the device. E.g. in Windows-based operating systems a program can be opened by clicking an icon representing the program, whereby the icon disappears and an application window appears on the display. The visual program representation of the opened program is now the application window, which is produced on the display. With terminal devices having graphic user interface it is common that there are several application windows opened one upon the other and only the one which is on the top is actually in use. In the present invention the application windows are treated the same way as the program icons. This means that the appearance of the application window will gradually weaken, i.e. chance to less noticeable form, if the application is not used during the observation periods. The application is considered to be used if the application executes some operations or if the application window is at the topmost window of all opened windows.

In a preferred embodiment of the method according to the invention there are set two limit values, 1^{st} limit value and the 2^{nd} limit value, for the aging parameter. This embodiment is used especially to chance the appearance of an application window produced on the display. When the aging parameter reaches the 1^{st} limit value, the application window is closed, i.e. the window disappears from the display. After this the only visual indication of this program seen on the display is a program button on the toolbar. Although the application window is closed, the method steps are still repeated until the aging parameter reaches the 2^{nd} limit value. At this stage the application is finally closed, whereby also the toolbar button disappears.

As shown above, the terminal device 100 and method according to the invention enable automatic changing of the appearance of the visual program representative produced on the display such that the appearance of the visual representative reflects the operation frequency of the program. The method according to the invention is used by the display controller 108 that controls the content of the display 102 of the terminal device 100. The method may be achieved by executing a computer-readable medium-storing program code for changing the appearance of the visual program representative, such as icon or window, which is produced on the displays 102 of the terminal device 100. The computer program code according to the present invention may be stored in any one of the computer-readable media including Read-Only Memories (ROMs), Random Access Memories (RAMs), magnetic disks, magnetic tapes and optical disks. When executed by the display controller 108, the program code will cause the display controller to perform each step of the method according to the present invention. The user of the terminal device may set and change the program parameters, such as the length of the observation period and the limit values of the aging parameters using the user interface unit 106 of the device.

Some advantageous embodiments according to the invention are described above. It will be apparent to those skilled in the art that various modifications and variations can be made in the present invention without departing from the spirit or scope of the invention. Thus the inventive idea can be applied in numerous ways within the scope defined by the claims attached hereto.

1. A method for chancing the appearance of a visual program representative produced on the display of the terminal device, the method comprising the steps of:
observing the operation frequency of the program represented by the visual program representative for a predetermined period of time, called the observation period,
measuring the operation frequency of the program during the observation period and
changing the appearance of the visual program representative such that the changed appearance reflects the operation frequency of the program during the past observation period.

2. The method according to claim 1, wherein the appearance of the visual program representative is chanced to a less noticeable form, if the program has not been used during the past observation period.

3. The method according to claim 2, wherein the changing of the appearance of the visual program representative is made by diminishing the size of the visual program representative.

4. The method according to claim 2, wherein the changing of the appearance of the visual program representative is made by changing the colouring of the visual program representative.

5. The method according to claim 1, wherein the original appearance of the visual program representative is recalled, if the program has been used during the past observation period.

6. The method according to claim 1, wherein the method steps are repeated in cycles for observing, measuring and changing the appearance of the visual program representative continuously.

7. The method according to claim 6, wherein the visual program representative is removed from the display, if the program has not been used during predetermined number of consecutive observation periods.

8. The method according to claim 6, wherein the program represented by the visual program representative is closed, if the program has not been used during predetermined number of consecutive observation periods.

9. The method according to claim 6, wherein latest appearance of the visual program representative is saved into the memory of the terminal device.

10. The method according to claim 6, wherein said visual program representative is a program icon or an application window.

11. A terminal device, comprising
a memory for storing the information concerning the appearance of a visual program representative,
a display for displaying visual program representatives, and
a display controller coupled to the memory and the display for
observing the operation frequency of the program represented by the visual program representative for a predetermined period of time, called the observation period,
measuring the operation frequency of the program during the observation period and
changing the appearance of the visual program representative such that the changed appearance reflects the operation frequency of the program during the past observation period.

12. The terminal device according to claim 11, wherein the appearance of the visual program representative is changed to a less noticeable form, if the program has not been used during the past observation period.

13. The terminal device according to claim 11, wherein the original appearance of the visual program representative is recalled, if the program has been used during the past observation period.

14. The terminal device according to claim 11, the visual program representative is removed from the display, if the program has not been used during predetermined number of consecutive observation periods.

15. The terminal device according to claim 11, wherein the program represented by the visual program representative is closed, if the program has not been used during predetermined number of consecutive observation periods.

16. The terminal device according to claim 11, wherein said visual program representative is a program icon or an application window.

17. A computer software product, comprising:
a computer-readable medium-storing program code for changing the appearance of a visual program representative produced on a display of a terminal device, the program code, when executed by a display controller, causing the display controller to:
observe the operation frequency of the program represented by the visual program representative for a predetermined period of time, called the observation period,
measure the operation frequency of the program during observation period and
change the appearance of the visual program representative such that the changed appearance reflects the operation frequency of the program during the past observation period.

18. The software product according to claim 17, wherein the appearance of the visual program representative is chanced to a less noticeable form, if the program has not been used during the past observation period.

19. The software product according to claim 18, wherein the changing of the appearance of the visual program representative is made by diminishing the size of the visual program representative.

20. The software product according to claim 18, wherein the changing of the appearance of the visual program representative is made by changing the colouring of the visual program representative.

21. The software product according to claim 17, wherein the original appearance of the visual program representative is recalled, if the program has been used during the past observation period.

22. The software product according to claim 17, wherein the method steps are repeated in cycles for observing, measuring and changing the appearance of the visual program representative continuously.

23. The software product according to claim 22, wherein the visual program representative is removed from the display, if the program has not been used during predetermined number of consecutive observation periods.

24. The software product according to claim 22, wherein the program represented by the visual program representative is closed, if the program has not been used during predetermined number of consecutive observation periods.

25. The software product according to claim 22, wherein latest appearance of the visual program representative is saved into the memory of the terminal device.

26. The software product according to claim 22, wherein said visual program representative is a program icon or an application window.
